(19) United States
(12) Patent Application Publication
(10) Pub. No.: US 2021/0013724 A1
(43) Pub. Date: Jan. 14, 2021

(54) CONVENIENCE CHARGER AND COMBINATION

(71) Applicant: HCL DESIGNS, LLC, Naples, FL (US)

(72) Inventors: Michael BERGMAN, Somerville, MA (US); Robert E. Tuffy, Hanover, MA (US)

(73) Assignee: HCL DESIGNS, LLC, Naples, FL (US)

(21) Appl. No.: 17/035,287

(22) Filed: Sep. 28, 2020

Related U.S. Application Data
(63) Continuation of application No. PCT/US2019/024151, filed on Mar. 26, 2019.
Application No. PCT/US2019/024151 is a continuation-in-part of application No. 15/859,485, filed on Dec. 30, 2017.
Application No. 15/859,485 is a continuation-in-part of application No. PCT/US2016/040883, filed on Jul. 1, 2016.
Application No. PCT/US2016/040883 is a continuation-in-part of application No. 15/859,485, filed on Dec. 30, 2017.
Application No. 15/859,485 is a continuation-in-part of application No. 29/603,444, filed on May 9, 2017, now Pat. No. D835034.
Application No. 29/603,444 is a continuation-in-part of application No. 29/604,372, filed on May 17, 2017, now Pat. No. D824851.
Application No. 29/604,372 is a continuation-in-part of application No. 29/604,439, filed on May 17, 2017, now abandoned.
Application No. 29/604,439 is a continuation-in-part of application No. 16/405,893, filed on May 7, 2019.
Application No. 16/405,893 is a continuation of application No. PCT/US2017/060470, filed on Nov. 7, 2017.
Application No. PCT/US2017/060470 is a continuation-in-part of application No. 16/905,671, filed on Jun. 18, 2020.
Application No. 16/905,671 is a continuation of application No. PCT/US2018/066319, filed on Dec. 18, 2018.
(60) Provisional application No. 62/648,362, filed on Mar. 26, 2018.
(60) Provisional application No. 62/187,389, filed on Jul. 1, 2015.
(60) Provisional application No. 62/262,722, filed on Dec. 3, 2015.
(60) Provisional application No. 62/277,892, filed on Jan. 12, 2016.
(60) Provisional application No. 62/343,084, filed on May 30, 2016.
(60) Provisional application No. 62/418,556, filed on Nov. 7, 2016.
(60) Provisional application No. 62/461,175, filed on Feb. 20, 2017.
(60) Provisional application No. 62/483,458, filed on Apr. 9, 2017.
(60) Provisional application No. 62/525,255, filed on Jun. 27, 2017.
(60) Provisional application No. 62/607,308, filed on Dec. 18, 2017.
(60) Provisional application No. 62/624,827, filed on Feb. 1, 2018.

(51) Int. Cl. H02J 7/00; H02J 50/00

(52) U.S. Cl. CPC H02J 7/0044; H02J 50/005

(57) ABSTRACT

A charging station includes a body portion with a mains voltage electrical receptacle and a voltage converter portion, and a removable convenience feature where the removable convenience feature includes a coupling member and a support column, and where the charging station includes at least one additional electrical receptacle arranged to provide power to a personal electronic device.

### CROSS-REFERENCE TO RELATED APPLICATIONS

The present application is a U.S. Nonprovisional Application under 35 U.S.C. 111(a) (bypass) of international application PCT/US2019/024151, having an international filing date of Mar. 26, 2019, and published as WO2019/191147, which in turn claims the benefit of U.S. provisional patent application 62/648,362 filed on Mar. 26, 2018 the disclosures of all of the foregoing are incorporated in the present application by reference in their entirety. The present application is a continuation-in-part of co-pending U.S. patent application Ser. No. 15/859,485 filed on Dec. 30, 2017, which is a continuation-in-part of international application number PCT/US2016/040883 filed on Jul. 1, 2016 and published as WO2017/004604, which in turn claims the benefit of U.S. provisional patent application 62/187,389 filed on Jul. 1, 2015, and claims the benefit of U.S. provisional patent application 62/262,722 filed on Dec. 3, 2015, and claims the benefit of U.S. provisional patent application 62/277,892 filed on Jan. 12, 2016, and claims the benefit of U.S. provisional patent 62/343,084 filed on May 30, 2016 the disclosures of all of the foregoing are incorporated in the present application by reference in their entirety. The present application is a continuation-in-part of co-pending U.S. patent application Ser. No. 15/859,485 filed on Dec. 30, 2017, which is a continuation-in-part of U.S. design application 29/603,444 filed on May 9, 2017, and is a continuation-in-part of U.S. design application 29/604,372 filed on May 17, 2017, and is a continuation-in-part of U.S. design application 29/604,439 filed on May 17, 2017 the disclosures of all of the foregoing are incorporated in the present application by reference in their entirety. The present application is a continuation-in-part of co-pending U.S. patent application Ser. No. 16/405,893 filed on May 7, 2019, which is a continuation of international application number PCT/US2017/060470 filed on Nov. 7, 2017, and published as WO2018/085860 which in turn claims the benefit of U.S. provisional patent application 62/418,556 filed on Nov. 7, 2016 and claims the benefit of U.S. provisional patent application 62/461,175 filed on Feb. 20, 2017, and claims the benefit of U.S. provisional patent application 62/483,458 filed on Apr. 9, 2017, and claims the benefit of U.S. provisional patent 62/525,255 filed on Jun. 17, 2017 the disclosures of all of the foregoing are incorporated in the present application by reference in their entirety. The present application is a continuation-in-part of co-pending U.S. patent application Ser. No. 16/905,671 filed on Jun. 8, 2020, which is a continuation of international application number PCT/US2018/066319 filed on Dec. 18, 2018, and published as WO2019/126278 which in turn claims the benefit of U.S. provisional patent application 62/607,308 filed on Dec. 18, 2017 and claims the benefit of U.S. provisional patent application 62/624,827 filed on Feb. 1, 2018 the disclosures of all of the foregoing are incorporated in the present application by reference in their entirety.

### FIELD OF THE INVENTION

The present invention relates to electronic systems, and more particularly to electronic device charging systems.

### SUMMARY

Access to information, and personal availability for communication, are defining characteristics of our era. This access and availability are ubiquitous and continuous. Almost everyone is online all the time.

Much of the bandwidth involved in these communications is devoted to trivialities. Nevertheless, within the mass of inconsequential information there are individual items that, alone or in combination, have great consequence for our social and commercial relationships. We all understand that missing one item of information or failing to respond to a crucial inquiry from a client or social partner can have a disproportionate impact on our lives. Because of this, many of us have come to rely deeply on our personal electronic devices in ways that we perceive both consciously and intuitively. As a result, there is an urgent motivation to keep these devices functional.

The inventors of the present invention have, through personal experience, analysis, and the careful observation of human behavior, come to understand the depth and force of this motivation. They appreciate the degree to which wide swaths of society feel compelled to maintain and preserve the continuity and functionality of their information links, and the depth of the impulse to ensure that a personal communication device (such as a cell phone, smart phone, tablet, laptop computer, etc.) is charged and operational.

The inventors have observed that this impulse is particularly strong for those who are traveling on business, and those in problematic social situations, where the abundance of communication channels one might find in, e.g., an office setting, is reduced to one or two devices. In these situations, access to a crucial data point such as a delayed airplane departure, a breaking political news item, a sports outcome or a missed phone call from a client, a child, a spouse or other partner can have all the import for life success of the proverbial horseshoe nail.

At the same time, those who provide environments and accommodations to these mobile users face stiff competition for patrons and customers. They are strongly motivated to make their facilities attractive and functional, so as to entice what is often the most lucrative market segment into their businesses. They seek to develop a coherent aesthetic experience, an atmosphere, that is pleasant and inviting, and that provides every desirable resource and convenience without exposing their patrons to obtrusive reminders of the stressors that are constantly pending at the edge of consciousness.

The inventors, thus appreciating the importance of combining functionality with unobtrusive beauty, have arrived at certain new and useful inventions as further described herewith. Specifically, the inventors have come to appreciate that there is great utility to be found in a charging receptacle for a personal electronic device, where that charging receptacle is designed for discrete and aesthetically attractive placement in commercial and private establishments, localized adjacent to dining and working facilities.

They have further come to understand and appreciate that combining such a charging receptacle with additional convenience features such as, for example, a coat hook, a pocketbook support, a personal device support, a luggage rack, and many other features, of which the foregoing are merely exemplary, can have great utility and benefit. They have observed that these important elements and combinations are novel. Moreover they have discovered that these inventions can have a commercial and functional significance that is surprisingly important and beneficial in ways that are very unexpected.

As will be further described below, with reference to exemplary embodiments and aspects thereof, a device prepared according to the invention will include a localized electronic receptacle. In certain embodiments, this localized electronic receptacle will include a convenience feature. In certain examples, the electronic receptacle will be a USB receptacle of any known or anticipated size, and the convenience feature will be a pocketbook hook.

In one embodiment, the invention includes a system having a charging station with a removable convenience feature. The charging station is configured and adapted to be substantially permanently mounted below a generally horizontal surface such as the underside of a table, a high top table, or a service bar. The charging station is adapted to receive mains power and to supply electrical power at a useful voltage to a user of the table, high top or service bar.

In one embodiment, the charging station will include a body portion including a structural member and an electronic circuit board. An exemplary body portion will include an enclosure formed of folded sheet metal, diecast metallic alloy, polymer, or other appropriate structural material. The circuit board will be mechanically coupled within the body portion and provide power at a reduced electrical voltage to supply a USB receptacle as known in the art. In addition, certain embodiments of the invention will include an illumination device such as, for example and without limitation, a light emitting diode (LED). In a further aspect of certain embodiments, light will be conducted from the illumination device to an external surface of a convenience feature module by a transparent or translucent polymer material.

In a still further aspect of certain embodiments, the charging station includes a removable convenience feature module. The removable convenience feature module will be coupled to a body portion with a plurality of screws. In addition, in certain embodiments, removable convenience feature module will include a support member with a proximal end that fits within a socket of the body portion.

In still other embodiments of the invention, a circuit board as well as mains voltage components will be permanently sealed within the body portion by employing a bonding techniques such as, for example, thermal welding, arc welding, ultrasonic welding, laser welding, or any other bonding method known or that becomes known in the art.

In certain embodiments of the invention, the convenience feature module includes a shelf to support a personal electronic device and in certain embodiments, the shelf will include a wireless charging apparatus to wirelessly recharge the personal electronic device.

Exemplary physical configurations and designs are illustrated in the attached figures and it will be understood that one of skill in the art, having perceived the utility of the present invention, will readily derive other valuable and serviceable configurations of the invention, all of which are intended to fall within the scope of the present disclosure.

In certain embodiments, the body portion will exhibit a longitudinal axis, where the longitudinal axis is adapted to be disposed in a generally horizontal orientation. Certain embodiments of the invention will be arranged for operative mounting with the longitudinal axis in alternative orientations.

The following description is provided to enable any person skilled in the art to make and use the disclosed inventions and sets forth the best modes presently contemplated by the inventors of carrying out their inventions. In the following description, for purposes of explanation, numerous specific details are set forth in order to provide a thorough understanding of the present invention. It will be apparent, however, to one skilled in the art that the present invention may be practiced without these specific details. In other instances, well-known structures and devices are shown in schematic form in order to avoid unnecessarily obscuring the substance disclosed. These and other advantages and features of the invention will be more readily understood in relation to the following detailed description of the invention, which is provided in conjunction with the accompanying drawings.

It should be noted that, while the various figures show respective aspects of the invention, no one figure is intended to show the entire invention. Rather, the figures together illustrate the invention in its various aspects and principles. As such, it should not be presumed that any particular figure is exclusively related to a discrete aspect or species of the invention. To the contrary, one of skill in the art would appreciate that the figures taken together reflect various embodiments exemplifying the invention as a whole, and any feature found in one figure is considered to be a feature of the invention as a whole.

Correspondingly, referenced throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

### BRIEF DESCRIPTION OF THE DRAWINGS

FIG. 1 shows, in perspective side view, an exemplary charging system prepared according to principles of the invention;

FIG. 2 shows, in three quarters perspective view, further aspects of a charging station prepared according to principles of the invention;

FIG. 3 shows a proximal elevation of a charging station prepared according to principles of the invention;

FIG. 4 shows, in distal perspective view, a charging station prepared according to principles of the invention;

FIG. 5 shows, in schematic perspective view, further aspects of a charging station prepared according to principles of the invention;

FIG. 6 shows, in schematic form, a distal three quarters ventral perspective view of an exemplary body portion of a charging station prepared according to principles of the invention;

FIG. 7 shows, in cutaway schematic form, a distal three quarters ventral perspective view of a charging station further including a portion of a convenience feature module prepared according to principles of the invention;

FIG. 8A shows, in schematic side elevation, a charging station including a body portion and a convenience feature module disposed in a fully deployed configuration;

FIG. 8B shows the charging station of FIG. 8A with a convenience feature module disposed in a fully retracted configuration;

FIG. 8C shows, in schematic proximal elevation view, the charging station of FIG. 8A with a convenience feature module disposed in a fully retracted configuration;

FIG. 9 shows, in schematic proximal elevation view, a further charging station prepared according to principles of the invention;

FIG. 10 shows, in schematic three quarters perspective view, a further convenience feature module of a charging station prepared according to principles of the invention;

FIG. 11 shows, in cross-sectional side elevation view, a convenience feature for a charging station prepared according to principles of the invention;

FIG. 12 shows a convenience feature module for a charging station prepared according to principles of the invention;

FIG. 13A shows, in side perspective view, a portion of a USB module for a charging station prepared according to principles of the invention;

FIG. 13B shows, in schematic perspective view, a ventral region of a portion of a USB module for a charging station prepared according to principles of the invention;

FIG. 13C shows, in schematic perspective view, a USB module and a mechanical carrier portion for a charging station prepared according to principles of the invention;

FIG. 14 shows a ventral perspective schematic view of a portion of a charging station prepared according to principles of the invention;

FIG. 15 shows, in schematic cross-section, a side elevation of a charging station prepared according to principles of the invention;

FIG. 16 shows, in schematic cross-section, a side elevation of a charging station prepared according to principles of the invention;

FIG. 17A shows, in cutaway schematic perspective view, a mechanical arrangement of one exemplary power distribution module for a charging station prepared according to principles of the invention;

FIG. 17B shows, in rear perspective view, a mechanical arrangement of one exemplary power distribution module for a charging station prepared according to principles of the invention;

FIG. 18 shows a further embodiment of a charging station including a body portion and a convenience feature module prepared according to principles of the invention;

FIG. 19A shows, in an extended configuration, a further charging station including a convenience feature module prepared according to principles of the invention;

FIG. 19B shows, in a retracted configuration, a further charging station including a convenience feature module prepared according to principles of the invention;

FIG. 20 shows, in three quarters perspective view, a further embodiment of a charging station prepared according to principles of the invention;

FIG. 21 shows, in three quarters perspective view, a further embodiment of a charging station prepared according to principles of the invention; and

FIG. 22 shows, in three quarters perspective view, a further embodiment of a charging station prepared according to principles of the invention.

### DETAILED DESCRIPTION

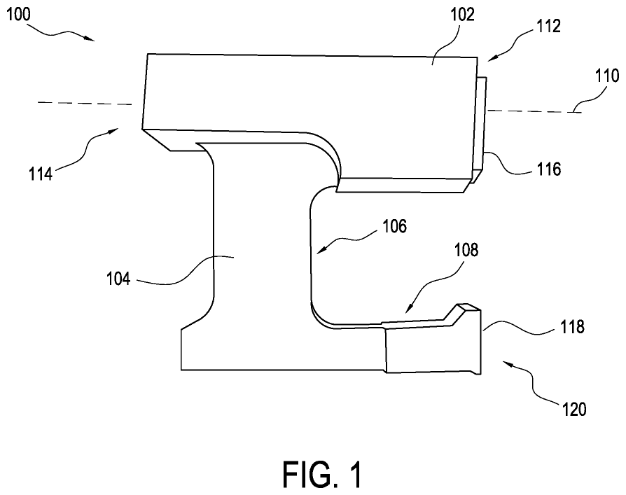

FIG. 1 shows, in perspective side view, a charging station 100 prepared according to principles of the invention. The charging station 100 includes a body portion 102 and a convenience feature 104. In the illustrated embodiment, the convenience feature includes a hook having a generally arcuate surface region 106 with an overall concave aspect. The surface region 106 includes a bearing surface region 108 adapted to support a personal article such as, for example, a handbag, a briefcase, or a jacket.

The body portion 102 exhibits a generally elongate form about a longitudinal axis 110 and has a first proximal end 112 and a second distal end 114. At the proximal end 112 of the body portion 102 is disposed a first electrical receptacle 116 arranged and configured for receiving, or otherwise coupling to, an electrical plug. In certain embodiments of the invention, the electrical plug includes a plug arranged in a standard NEMA 5-15 Type B configuration for the provision of mains power to any appropriate device. In the United States mains power is generally 120 V at 60 Hz AC.

In the illustrated embodiment, the convenience feature 104 includes a second electrical receptacle 118 at a proximal end 120, thereof. In the illustrated embodiment, the second electrical receptacle 118 is configured as an exemplary USB receptacle and is arranged and configured to receive a USB plug therewithin so as to form an electrical connection with an appropriate device. A typical USB receptacle is arranged and configured to supply electrical power at 5 V nominal.

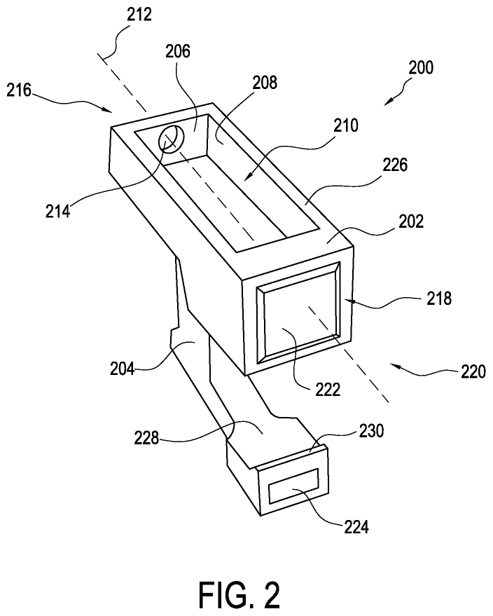

FIG. 2 shows, in three quarters perspective view further aspects of a charging station 200 prepared according to principles of the invention. Consistent with the description above, the charging station 200 includes a body portion 202 and a convenience feature 204. A plurality of internal surfaces e.g., 206, 208 of body portion 202 together define a recess or cavity 210 within the body portion about a longitudinal axis 212 thereof.

An aperture 214 at a distal end 216 of the body portion communicates between the cavity 210 and an exterior region. In certain embodiments of the invention, aperture 214 is arranged and configured to receive power supply wiring therethrough. A further aperture 218 at a proximal end 220 of body portion 202 is configured to receive a first receptacle 222 therewithin.

Although not illustrated in the present drawing, in certain embodiments of the invention, cavity 210 is arranged and configured to receive power conversion circuitry therewithin. Specifically, in certain embodiments, a circuit board is provided within cavity 210 that receives mains power through aperture 214 and produces 5 V DC to supply a USB receptacle e.g. 224.

Also not shown is wiring between the circuit board and the USB receptacle 224. One of skill in the art will understand that, in certain embodiments, a bore is provided within the convenience feature 204 within which is disposed low voltage wiring for this purpose. Other features not shown here, but which would be readily understood by one of skill in the art include a cover arranged to sit above or flush with an upper surface region 226 of body portion 202 and flanges, brackets, or other features arranged to couple an upper surface region of the body portion to a supporting surface such as, for example, the underside of a table, a bar, a serving cart, or any other mounting location appropriate to a particular application.

In the illustrated embodiment, the convenience feature 204 is configured as a hook with an upper supporting surface 228 and an exemplary detent feature 230. The illustrated detent feature 230 includes, for example, a protrusion. When in use, this detent feature 230 serves to prevent a handbag or other article supported by the hook from sliding off of surface region 228 by accident.

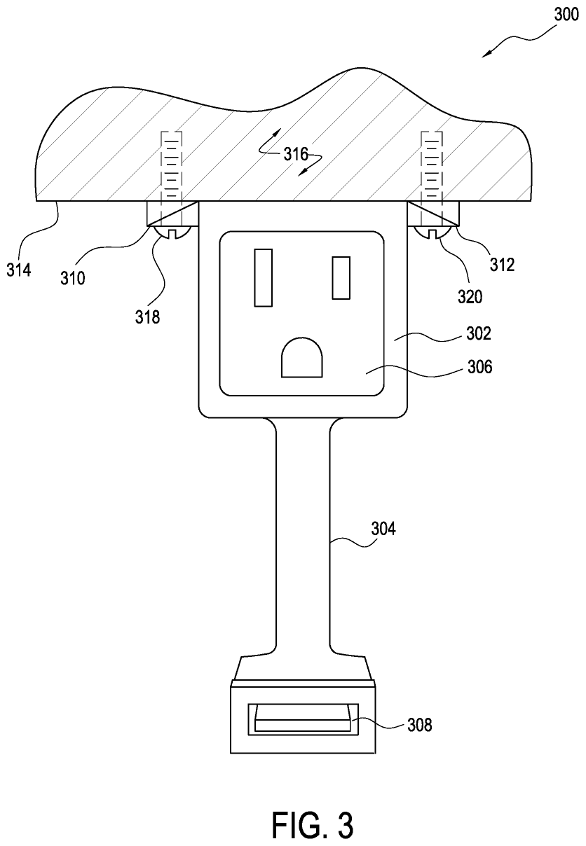

FIG. 3 shows a proximal elevation of a charging station 300 prepared according to principles of the invention. Consistent with the description above, the charging station 300 includes a body portion 302 and a convenience feature 304 configured as a hook for a personal article. A first exemplary electrical receptacle 306 is shown as a conventional 120 V NEMA 5-15 Type B outlet. A second exemplary electrical receptacle 308 is shown as a conventional USB outlet. One of skill in the art will appreciate, however, that any of a wide variety of outlets will be provided in respective embodiments of the invention. For example one, or a plurality of, further USB receptacles will be disposed at the location of receptacle 306 in corresponding embodiments of the invention. Of course any other appropriate electrical receptacle or other connectivity device can also be employed in place of any of the indicated receptacles.

Also schematically illustrated in FIG. 3 are first 310 and second 312 mounting flanges arranged and adapted to permit a strong and substantially permanent coupling of the charging station 300 to a supporting surface, e.g. 314 of a structural member 316 such as, for example, a tabletop or countertop. In certain embodiments, as illustrated schematically here, screws, such as wood screws, e.g. 318, 320 will be used to effect its attachment. In other embodiments, an adhesive is disposed between respective upper surface regions the flanges, e.g. 310, 312 and corresponding portions of the supporting surface 314. In still other embodiments, nails, rivets, or other fastening devices will be used. One of skill in the art will appreciate that any appropriate fastener will be employed to secure the desired attachment, and in any combination.

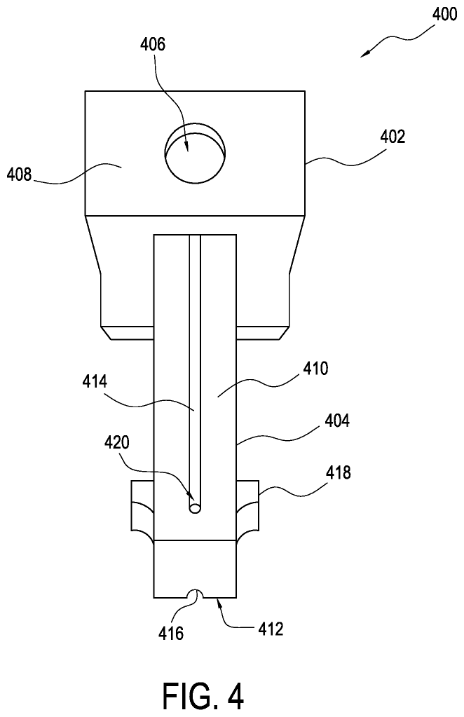

FIG. 4 shows, in distal perspective view, a charging station 400 prepared according to principles of the invention. Consistent with the description above, the charging station 400 includes a body portion 402 and a convenience feature 404. A distal aperture 406 is visible at a rear surface region 408 of body portion 402. In certain embodiments, this aperture 406 is adapted for power supply wiring to be disposed therethrough. In certain embodiments, aperture 406 will include internal threads for receiving an electrical coupling device prepared in a manner known in the art.

In the illustrated embodiment the convenience feature 404 includes a distal surface region 410 and a lower surface region 412. In certain embodiments, and as illustrated, a first groove 414 is defined in the distal surface region 410 and a second groove 416 is defined in the lower surface region 412. The first 414 and second 416 grooves are sized and arrange to accommodate, for example, low voltage wiring (not shown) that conveys power from a circuit board (not shown) within a cavity of the body portion 402 to, for example, a USB receptacle disposed within a proximal portion 418 of the convenience feature 404.

In selected embodiments of the invention, and as illustrated, an intermediate bore 420 communicates between first groove 414 and second groove 416, allowing convenient placement of the low voltage wiring therewithin. In certain embodiments, the low voltage wiring, once disposed within the respective grooves is secured in place with, for example, a cover, one or more mechanical fasteners, or an adhesive such as, for example, an epoxy, a latex base adhesive, a cyanoacrylate base adhesive, a thermoplastic material or a thermoset material, or any other appropriate fixing material such as is known or may become known in the art.

In alternative embodiments, one or more of the grooves 414, 416 will be substituted with a bore through an interior region of the convenience feature 404, once again adapted to receive electrical wiring or other apparatus (such as, e.g., optical communications apparatus) therewithin.

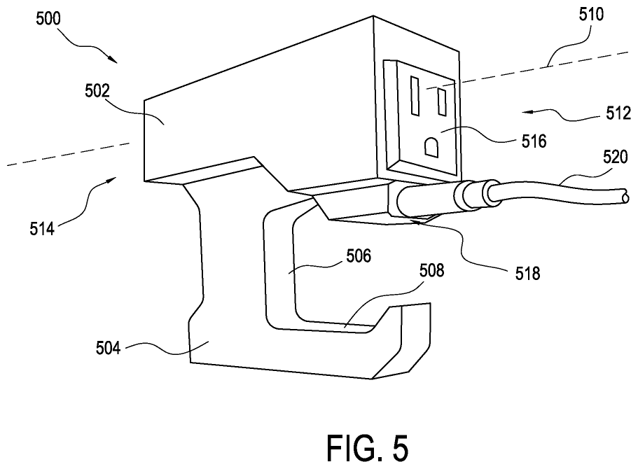

FIG. 5 shows, in schematic perspective view, further aspects of a charging station 500 prepared according to principles of the invention. The charging station 500 includes a body portion 502 and a convenience feature 504. In the illustrated embodiment, the convenience feature includes a hook having a generally arcuate surface region 506 with an overall concave aspect. The surface region 506 includes a bearing portion 508 adapted to support a personal article such as, for example, a handbag, a briefcase, or a jacket.

The body portion 502 exhibits a generally elongate form about a longitudinal axis 510 and has a first proximal end 512 and a second distal end 514. At the proximal end 512 of the body portion 502 is disposed a first electrical receptacle 516 arranged and configured for receiving, or otherwise coupling to, an electrical plug. In certain embodiments of the invention, the electrical plug includes a plug arranged in a standard NEMA 5-15 Type B configuration for the provision of mains power to any appropriate device. In the United States mains power is generally 120 V at 60 Hz AC.

In the illustrated embodiment, the body portion 502 also includes a second electrical receptacle 518 at proximal end 512, thereof. In the illustrated embodiment, the second electrical receptacle 518 is configured as an exemplary USB receptacle and is arranged and configured to receive a USB plug therewithin so as to form an electrical connection with an appropriate device. A typical USB receptacle is arranged and configured to supply electrical power at 5 V nominal.

Charging station 500 is shown with an exemplary USB charging cable 520 coupled to electrical receptacle 518. One of skill in the art will readily understand that this is a temporary connection, and that the charging cable 520 may be removed when use of the USB receptacle is complete.

As noted above, in the illustrated embodiment, convenience feature 504 includes a hook for supporting a personal article. The illustrated hook of convenience feature 504 does not include a further USB receptacle in the manner of receptacle 118 of FIG. 1. Nonetheless, it should be understood that a convenience feature including such a receptacle can readily be included with a body portion like body portion 502 which, itself, includes a USB receptacle 518. Thus, a charging station with more than one USB receptacle, one included in the body portion and one in the convenience feature portion is contemplated within the scope of the present invention.

More importantly it should be understood that, in certain embodiments of the invention, the body portion 502 and convenience feature portion 504 will be constructed as independent interchangeable modules. This aspect of the invention will be further discussed below.

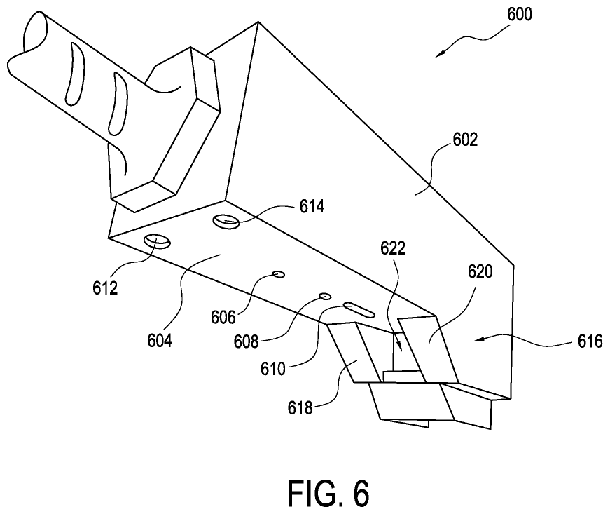

FIG. 6 shows, in schematic form, a distal three quarters ventral perspective view of an exemplary body portion 602 of a charging station 600 prepared according to principles of the invention. The body portion 602 is arranged and configured to have a removable and replaceable modular convenience feature coupled thereto.

Towards this end, the exemplary body portion 602 includes a ventral surface region 604 with first 606 and second 608 exemplary clearance holes. The clearance holes 606, 608 communicate with an internal cavity or recess of the body portion (not shown). When in use, clearance holes are adapted to, for example, align with corresponding internally threaded holes of a particular convenience feature module such that respective screws can be disposed within the first 606 and second 608 clearance holes and threaded into the respective internally threaded holes of the convenience feature. In this manner, the convenience feature can be substantially fixedly secured to the body portion 602.

In addition, the illustrated body portion 602 includes a slot 610 in surface region 604. This slot allows for the communication of electrical conductors, or other apparatus, between a circuit board disposed within the internal cavity or recess of the body portion, and the convenience feature module (not shown here). Accordingly, for example, electrical power can be provided to a convenience feature module having a USB receptacle in the manner of receptacle 118 (of FIG. 1), or for a variety of other purposes, as will be further discussed below. It will be understood that, in certain embodiments, a plug or receptacle will be provided either within or adjacent to the slot so that a connection between conductors of the body portion and corresponding conductors of the convenience feature portion will automatically be made when the convenience feature module is coupled to the body portion.

In addition to the clearance holes 606, 608, the exemplary body portion illustrated includes internally threaded holes 612, 614 in surface region 604 as shown. Like clearance holes 606, 608, internally threaded holes 612, 614 are available to receive fasteners for substantially fixedly coupling a convenience feature module to the body portion 602. However, whereas screws are passed from within the interior cavity of the body portion 602 through exemplary clearance holes 606, 608 and into internally threaded holes (or alternately nuts) of the convenience feature module, screws are passed inwardly through clearance holes of the convenience feature module and into internally threaded holes 612, 614; the difference being that the screw heads of the screws corresponding to clearance holes 606 and 608 are disposed within the internal cavity of the body portion 602, but the screw heads of the screws corresponding to exemplary internally threaded holes 612, 614 are disposed outwardly of the apparatus.

Consequently, if the convenience feature module is installed using clearance holes 606, 608, its screw heads are confined within the body portion 602 and therefore substantially inaccessible to the ultimate user. If the convenience feature module is installed using internally threaded holes 612, 614 the screw heads are accessible to the ultimate user. Therefore, it is possible to provide an apparatus where the ultimate user is able to exchange convenience feature modules after manufacture of the charging station and, in some cases, after its installation and/or use.

It will be appreciated that, in certain embodiments of the invention, only one or the other of the clearance holes and internally threaded holes will be provided in a particular instance of the body portion. In alternative embodiments, both sets of holes will be provided so as to minimize a requirement for alternative inventory. Beyond this, it should be understood that either the internally threaded holes, or the clearance holes, or both (where, e.g., exceptional strength of coupling is required), will be used when the convenience feature module is applied to the body portion.

In the exemplary body portion 602 illustrated, the body portion also includes a further coupling feature 616 including, for example, first 618 and second 620 triangular flange regions and an aperture 622 disposed between flange regions 618, 620.

In the illustrated embodiment aperture 622 is shown as a substantially rectangular aperture. It will be understood by one of skill in the art, however, that a wide variety of other aperture shapes will be provided in corresponding embodiments of the invention. In like fashion, the shape of the triangular flange regions will, in alternative embodiments of the invention, be chosen otherwise. Any shape found to be functional, and/or to have decorative appeal will be appropriately employed in a respective application of the invention.

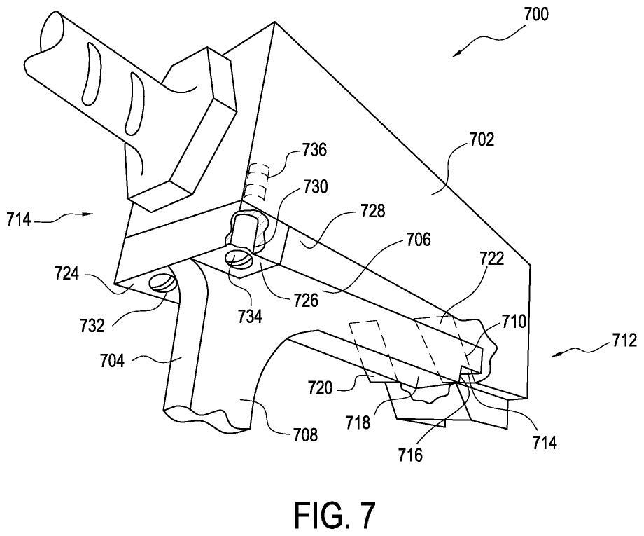

FIG. 7 shows, in cutaway schematic form, a distal three quarters ventral perspective view of charging station 700, which is like charging station 600, and includes a body portion 702. Charging station 700 is shown further including a portion of a convenience feature module 704.

The convenience feature module 704 includes a mounting member 706 and a support column 708. The mounting member 706 includes a projection portion 710 at a proximal end 712 thereof. A cross-sectional profile of the projecting portion is arranged to be substantially equal to a corresponding cross-section of aperture 622 (as illustrated in FIG. 6 above). In the illustrated embodiment, this cross-section is substantially rectangular in form. As noted above, however, a wide variety of other geometric forms are found in respective alternative embodiments of the invention.

When the convenience feature module 704 is installed, and substantially fixedly coupled to the corresponding body portion 702, a generally horizontal lower surface region 714 of the projection portion 710 is disposed in contact with, and supported by, a corresponding generally horizontal upper internal surface region of the body portion within aperture 622. Similarly, a generally vertical surface region 716 of the projection portion 710 is disposed in contact with, and supported against motion and a distal direction by, a corresponding generally vertical internal surface region of the body portion 702 adjacent to the aperture 622. In like fashion, a further generally horizontal lower surface region 718 of the projection portion 710 is disposed in contact with, and supported by, a corresponding generally horizontal upper internal surface region of the body portion 702 adjacent to aperture 622.

In this manner, the above-noted internal surface regions of the body portion serve to support and restrain the proximal end 712 of the mounting member 706 against downward and forward motion. Similarly, respective internal surface regions of flange portions 720, 722 serve to support and restrain the proximal end 712 of mounting member 706 against lateral motion. In sum, the form of the internal surface regions adjacent the aperture 622 serve to capture and support the proximal end of the mounting member 706.

One of skill in the art will appreciate that this function (i.e. constraint and support of the mounting member), can be achieved with a wide variety of other geometric configurations and spatial arrangements of elements and services. The arrangement described here is merely exemplary of these many other possibilities, all of which are taught to one of skill in the art by the present disclosure, and all of which are accordingly herewith disclosed.

In the illustrated embodiment, the convenience feature module 704 includes first 724 and second 726 mounting flanges at a distal end 714 thereof. Mounting flanges 724 and 726 have respective upper surface regions disposed adjacent to corresponding portions of ventral surface region 728.

Respective clearance holes, e.g., 730 of the mounting flanges 724, 726 are adapted to contain respective portions of mounting screws 732, 734 which are threaded into, and thus substantially fixedly retained within, threaded bores, e.g. 736 of body portion 702. It will be apparent to one of skill in the art that, by disposing mounting screws 732, 734 within the clearance holes, e.g. 730, and the internally threaded bore, e.g., 736 the convenience feature 704 is substantially fixedly attached to the body portion 702. The screws 732, 734 act in conjunction with the internal surface regions adjacent the aperture 622, to substantially fixedly couple the convenience feature 704 to the body portion 702 in a manner adapted to support a load consistent with design characteristics of the convenience feature.

It should be noted that the illustrated screw heads are merely exemplary of the many different types of screws available in the art (or that may become available in the art) including cap screws, flat head screws, Phillips head screws, security screws (which are removable only with a specially keyed tool), hex bolts, etc. Beyond this, it will be apparent to one of skill in the art in light of the present disclosure that other means and mechanisms for coupling the replaceable convenience feature module to the body portion will be possible, including those known and yet to be discovered including, without limitation, rivets, barbed nail devices, adhesives, temporary weldments, permanent weldments, etc. Such means and mechanisms are all intended to be within the scope of the present disclosure.

In light of the foregoing discussion, one of skill in the art will readily appreciate that the support column 708 of the convenience feature 704 will be useful in conjunction with the wide variety of convenience feature characteristics. Thus while charging station 100 above exhibits a convenience feature with a USB receptacle at a lower proximal extremity, charging station 500 above includes a convenience feature with a simple hook aspect. Accordingly, in conjunction with an appropriate embodiment of the invention, a wide variety of convenience features will be beneficially employed.

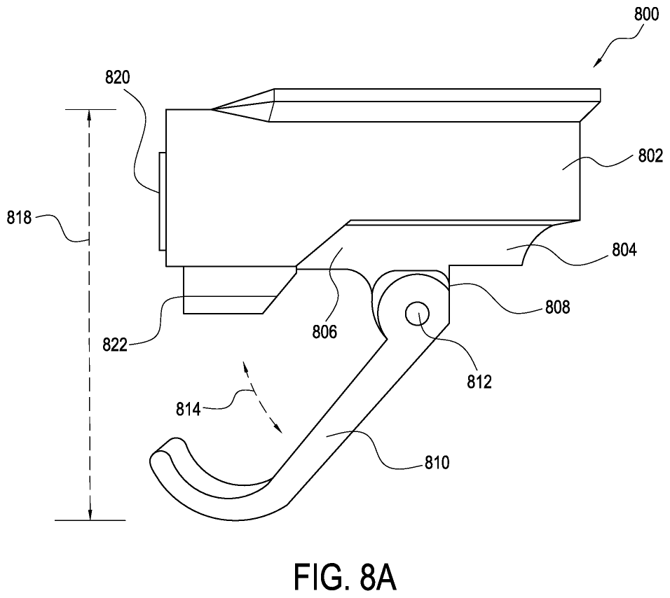

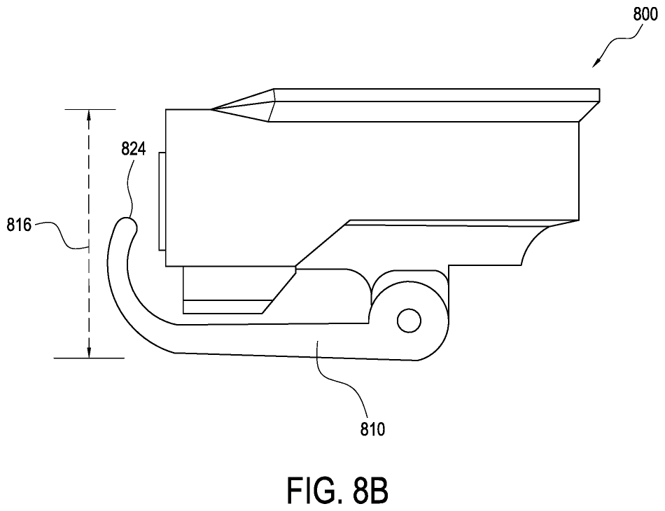

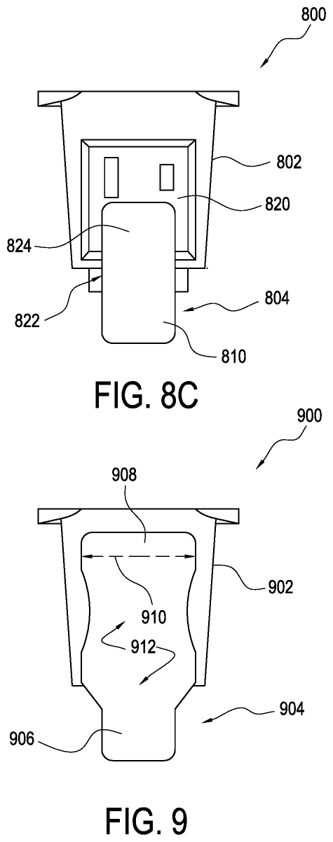

FIG. 8A shows, in schematic side elevation, a charging station 800 including a body portion 802 and a convenience feature module 804. The convenience feature 804 includes a mounting member 806 and a support column 808. Of course, in certain exemplary embodiments, the mounting member 806 and support column 808 are integrally formed, or permanently integrated, during manufacture. As shown, the support column 808 is pivotally coupled to a hook member 810 at a hinge or pivotal axle 812. Consequently, the hook member 810 is capable of being pivoted along an arcuate path 814 between a fully extended or deployed configuration (as shown FIG. 8A) and a fully retracted configuration as shown in FIG. 8B.

As suggested above, FIG. 8B shows the charging station 800 of FIG. 8A with hook member 810 disposed in a fully retracted configuration. In this configuration, a retracted overall height 816 of the charging station 800 is significantly less than the fully deployed overall height 818 of the charging station 800.

One of skill in the art will appreciate that, when a charging station 800 is installed beneath, e.g., a table, the smaller overall height 816 of the charging station 800 in its retracted configuration will minimize the likelihood that a user of the table will strike a knee or thigh on the hook member 810, as compared with the extended configuration of FIG. 8A, and as compared with a charging station of fixed height.

Thus, the hook member will be beneficially retained in the fully retracted configuration of FIG. 8B until such time as a user desires to hang a personal article on the hook or to charge, for example, a personal electronic device using one or the other of exemplary receptacles 820, 822. At such time, the user will apply pressure to a convenient portion e.g., 824 of the hook member 810 so as to cause it to transition from the fully retracted configuration of FIG. 8B to the fully deployed configuration of FIG. 8A, or to some desirable intermediate configuration.

In certain embodiments of the invention, a spring mechanism (not shown) is disposed within the convenience feature module 804. The spring mechanism is arranged and configured to urge the hook member 810 into the fully retracted configuration of FIG. 8B until a countervailing force is applied to the hook member. One of skill in the art will readily appreciate, however, that a personal article hung upon hook member 810 will tend to apply this countervailing force by the action of gravity on the personal article.

FIG. 8C shows, in schematic proximal elevation view, the charging station 800 of FIGS. 8A and 8B. Included is the body portion 802, the hook member 810 of convenience feature 804 (arranged in the fully retracted configuration of FIG. 8B), and a mains voltage receptacle 820. It will be apparent that the mains voltage receptacle 820 is partially concealed behind a portion 824 of the hook member 810, which also substantially conceals a further USB receptacle 822. As described above, when a user wishes to use either of the receptacles 820, 822, or to hang an article on the hook member 810, it is only necessary to urge hook member 810 downward to gain access to these functionalities.

FIG. 9 shows, in schematic proximal elevation view, a charging station 900 prepared according to principles of the invention. The charging station is similar to a charging station 800 of FIGS. 8A-8C, and includes a body portion 902 and a convenience feature module 904 with a hook member 906. As will be evident on inspection, the hook member 906 exhibits, at a proximal region thereof 908, an enlarged lateral dimension 910 as compared with region 824 of hook member 810 (of FIG. 8C).

As is apparent, the consequence of this enlarged lateral dimension 910 is that proximal region 908 of hook member 906 conceals the underlying receptacle(s) more fully than the corresponding portion 824 of charging station 800. One of skill in the art will understand that this concealment will be aesthetically desirable in certain circumstances. Naturally, the exhibited dimensions are only exemplary and any of a variety of different dimensions and configurations will be applied according to the aesthetic and functional requirements of a particular application and circumstance.

Moreover, it will be apparent to one of skill in the art that, in certain circumstances, decorative surface features will be beneficially provided at a proximal surface region 912 of proximal region 908 to further enhance aesthetic appeal, to provide informational or advertising benefit, or for any other reason that may serve the purposes of the installer or the user. These decorative surface features may include painting, patterning and/or coating, surface printing, surface relief features, and/or any other desirable or otherwise beneficial features.

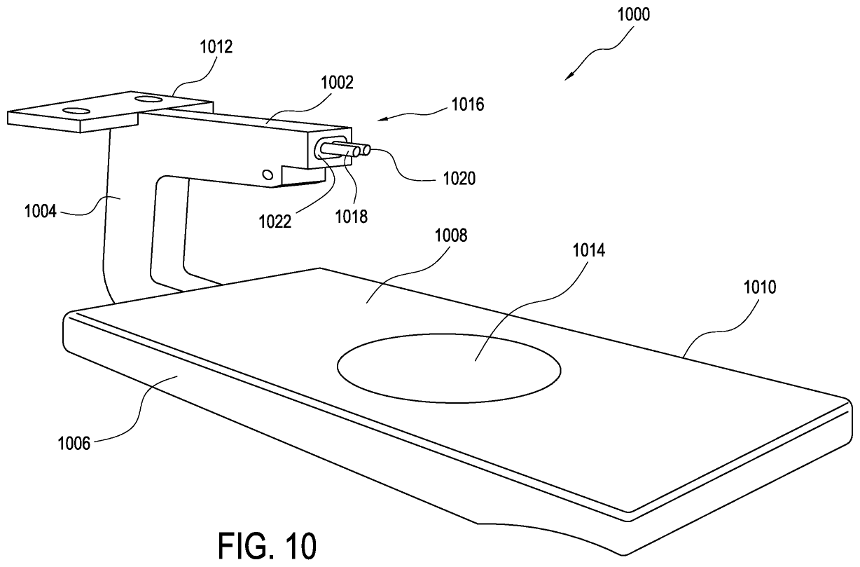

FIG. 10 shows, in schematic three quarters perspective view, a further convenience feature module 1000 of a charging station prepared according to principles of the invention. In considering convenience feature module 1000 it will be helpful to make further reference to FIGS. 6 and 7 which, it will be recalled, describe the interface between a removable convenience feature module and a corresponding charging station body portion. Convenience feature module 1000 includes a mounting member 1002, a support column 1004 and a shelf member 1006. The shelf member 1006 includes an upper surface region 1008 well adapted to support any of a variety of personal articles. In particular, shelf member 1006 will be used to support a personal electronic device such as a smart phone.

It will be noted that shelf member 1006 illustrated here has a generally rectangular peripheral edge 1010 and is envisioned to have dimensions roughly comparable to those of a typical smart phone. Nonetheless, the present disclosure is intended to cover shelf members of any shape, configuration or size according to the requirements of a particular application. Thus, by way of example and without limitation, a peripheral edge may be substantially circular, semicircular, polygonal, symmetrical, asymmetrical, and even malleable. Likewise the thickness and other dimensions of the illustrated shelf member are purely exemplary and other arrangements are contemplated. Moreover, the materials of the shelf member may include substantially rigid materials as well as more or less elastic and/or cushioned materials, textiles, foams, etc.

Beyond this, the flanges 1012 illustrated as part of the mounting member 1002 correspond to those of FIGS. 6 and 7, but are merely exemplary of many other shapes, thicknesses, arrangements, mounting hole numbers, etc. that may find beneficial application in practical instances of the invention. All such possibilities are intended to be included within the broad disclosure presented here.

One of skill in the art will be aware that many smart phones now include a wireless charging feature. Consistent with this, in certain embodiments of the invention, the shelf member 1006 will include a wireless charging interface element 1014 at, or adjacent to, surface region 1008.

State-of-the-art wireless charging interface elements presently typically include an electrical conductor disposed in a spiral and/or helical configuration and supported on a ferrite and/or ceramic member. It should be understood, however, that any wireless charging interface now present in the art or developed in the future may be included in a shelf member 1006 as contemplated in the present disclosure. Thus, for example, a photonic wireless charging interface, a thermal wireless charging interface, or any other future interface is intended to be within the present disclosure.

In certain embodiments, the mounting member 1002 includes an interface device, here shown an electrical plug 1016 with first 1018 and second 1020 substantially conductive pins disposed within a substantially insulating structural article 1022. It will be apparent that this electrical plug 1016 is intended to couple to a corresponding receptacle of a body portion (not shown) for energy and/or information transfer. Of course, the illustrated configuration is merely exemplary, and inversion of the plug and receptacle, as well as any of a wide variety of other interface devices are appropriate to corresponding embodiments of the invention.

Thus, in certain embodiments, multi-pin arrangements, flat contact arrangements, optical coupling arrangements, or any other appropriate device will be employed. In addition, in certain embodiments, conductors or other communication cables will be disposed between the convenience feature module and the body portion in a removable or a permanently fixed arrangement. The illustrated embodiment, however, is desirable in certain applications because it allows ready removal and replacement of the convenience feature associated with a particular body portion. Referring again to FIG. 6 it will be clear that, in the illustrated embodiment, pins 1018 and 1020 will pass through aperture 622 during installation of the convenience feature 1000.

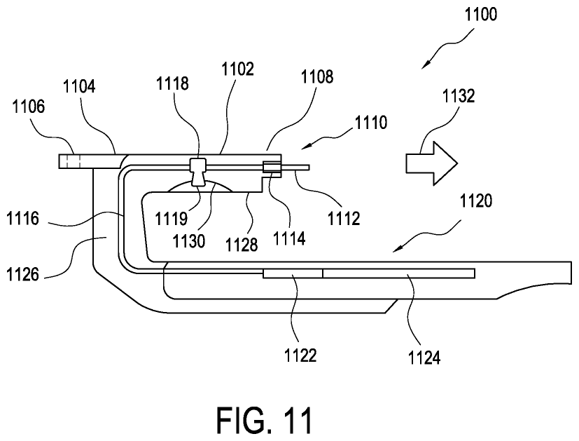

Consistent with the foregoing, FIG. 11 shows a cross-sectional side elevation view of a convenience feature 1100 for a charging station prepared according to principles of the invention. Convenience feature 1100 includes a mounting member 1102 with a plurality of flanges 1104. The illustrated flanges 1104 include a plurality of clearance holes 1106 that allow removably substantially fixed coupling of the convenience feature 1100 to a body portion of the charging station.

Mounting member 1102 also includes a proximal projection portion 1108 configured to be mechanically coupled with a corresponding receptacle feature of a body portion. The proximal projection portion includes an electrical connection plug 1110 with a plurality of conductive pins 1112 and an optional (depending on characteristics of the mounting member) insulating structural article 1114.

In the exemplary embodiment shown, the plurality of conductive pins 1112 are operatively coupled to a respective plurality of electrical conductors 1116 arranged and configured to supply, for example, electrical energy and/or data (encoded digitally or in analog format) to any appropriate device of the convenience feature 1100.

For example, and as illustrated, the electrical conductors 1116 will be operatively coupled to a lighting device such as a light-emitting diode (LED) apparatus 1118 and a wireless charging apparatus 1120. The wireless charging apparatus 1120 will include, for example, signal generation circuitry 1122 and an electro-magnetic charging coil 1124. Likewise, the light emitting diode apparatus 1118 will include, in certain embodiments, both a LED 1119 and appropriate lighting control circuitry. Of course, the use of an LED is merely exemplary of any other lighting device (other examples including incandescent lighting devices as well as fluorescent lighting devices and other plasma-based lighting devices).

It should be understood that the lighting control circuitry may include, for example, additional transducers such as an interface transducer for receiving and interpreting control signals related to color and/or intensity of lighting. In addition, the lighting control circuitry may be responsive to information signals related to operation of the signal generation circuitry 1122, or other circuitry, so that a color or other characteristic (e.g. blinking, steady, etc.) of light emitted by the LED will vary according to a status of the wireless charging apparatus and/or of the wired charging receptacle of the body portion (e.g., available, in use, charging, fully charged, etc.).

As illustrated, the electrical conductors 1116 are embedded within the mounting member 1102 and a support column 1126. Of course, in practical application any other arrangement including surface mounting, mounting within a groove, etc., are contemplated to be within the scope of the invention.

Also, as illustrated, mounting member 1102 has a lower surface region 1128 with a concave surface region 1130 configured as a reflector for light emitted by the LED 1119. Consistent with this use, concave surface region 1130 may include a reflective material and/or a reflective coating. In other embodiments, the mounting member 1102 may include a transparent or translucent material. This material may be included locally adjacent to the LED, or more generally throughout the mounting member 1102 and/or other portions of the convenience feature module 1100. In such an arrangement, light emitted by the LED 1119 is transmitted through the adjacent material to be viewed by a user.

In certain instances, a substantial portion of the convenience feature will be formed of, for example, a glass or polymer material having such a translucent or transparent characteristic. In such an embodiment, an embedded LED can be used to make the entire apparatus or a substantial portion thereof glow, providing a desirable aesthetic and/or functional effect. Again, and to be clear, this characteristic is not limited to a convenience feature for wireless charging, but to any convenience feature including a convenience feature with hooks, indicia, decorative elements, etc. Moreover, the power supply to the convenience feature at the conductive pins 1112 can be used for any beneficial application, far beyond mere illumination and charging of personal electronic devices.

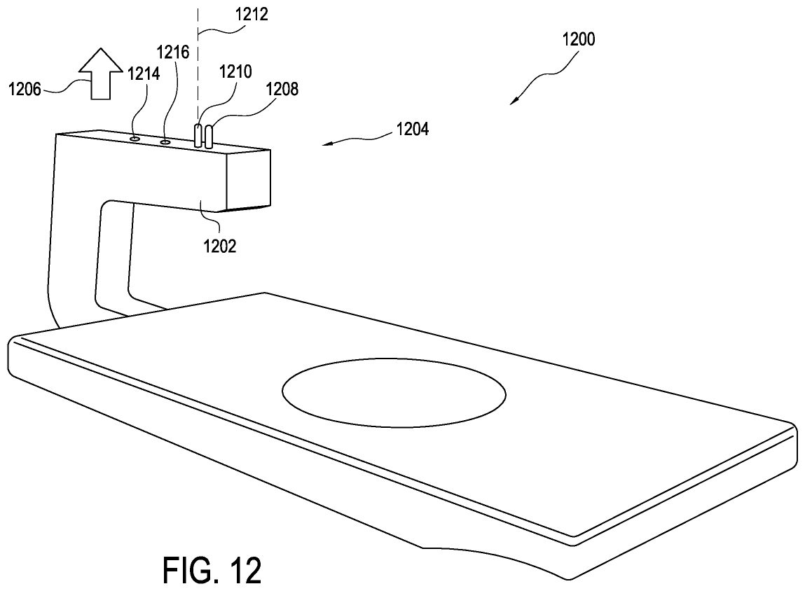

FIG. 12 shows a convenience feature module 1200 for a charging station prepared according to principles of the invention. Convenience feature module 1200 is similar in many respects to convenience feature module 1100 of FIG. 11. It will be apparent on inspection, however, that the interface between the present mounting member 1202 and the corresponding body portion of the charging station differs somewhat from that of mounting member 1102.

In particular, a proximal end 1204 of mounting member 1202 does not include the projection portion 1108 of convenience feature module 1100. Accordingly, whereas during installation of convenience feature module 1100 to a corresponding body portion, it is necessary to slide convenience feature module 1100 in a proximal direction 1132, this motion is not required for mounting of the convenience feature module 1200. Instead mounting of convenience feature module 1200 to a receiving body portion involves an upward vertical motion 1206 of the convenience feature module towards the lower surface region of the body portion.

Consistent with this different direction of installation, convenience feature module 1200 includes an electrical plug with conductive pins 1208, 1210 oriented along respective longitudinal axes, e.g., 1212, which are disposed in a generally vertical orientation. Referring again to FIG. 6, one of skill in the art will appreciate that pins 1208, 1210 are arranged to pass into slot 610 and engage with a corresponding receptacle at that location.

In like fashion, and as described in conjunction with FIG. 6, mounting member 1202 includes exemplary internally threaded bores 1214, 1216. In an appropriate embodiment, longitudinal axes of bores 1214 and 1216 will align with clearance holes 606 and 608 respectively so as to receive respective screws therewithin. In this manner, mounting member 1202 is substantially fixedly connected to a body portion such as 602.

Moreover, while convenience feature module 1200 may be removable from the body portion, removal may require access to screw heads within the body portion. As such, access to screw heads and removal of the convenience feature module from the body portion may be controlled as to a general user of the charging station. Of course, in other embodiments, it may be desirable for bores 1240 and 1216 to be clearance holes, while the holes at 606 and 608 are internally threaded or are coupled with nuts, etc. to allow external access and decoupling for this configuration of convenience feature module.

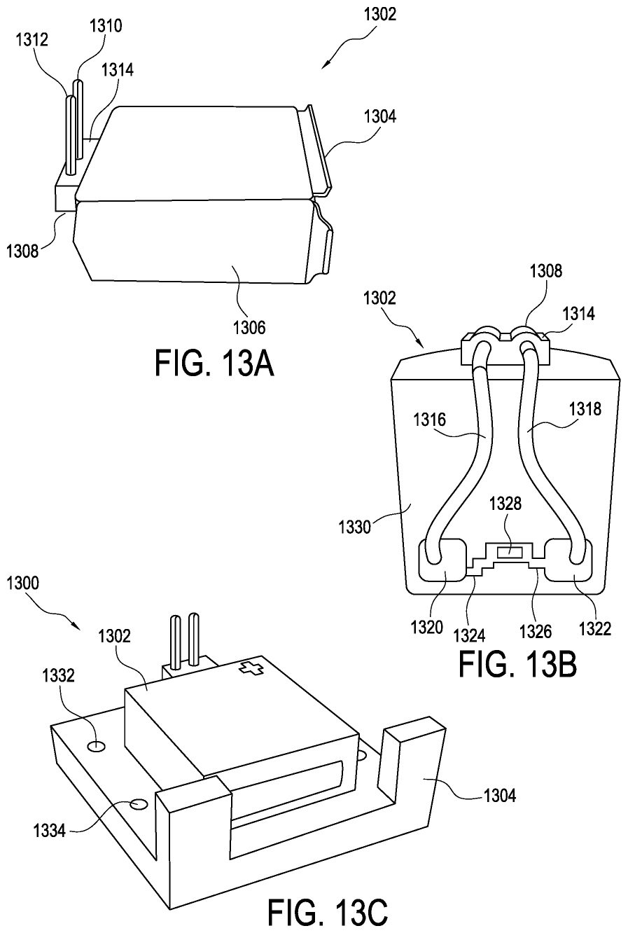

FIG. 13A-13C show, in schematic perspective view, various aspects of a USB module 1300 for a charging station prepared according to principles of the invention. The inventors have come to appreciate in the art that a USB receptacle presented for public use will, over time, be subject to wear, damage, and in some cases vandalism that tends to render the receptacle inoperable. Beyond this, from time to time, changes in technology may make it desirable to exchange an existing USB module for one of a different configuration or that otherwise exhibits different features. Accordingly, there will be circumstances in which it is desirable to remove and replace the USB receptacle of a charging station prepared according to principles of the invention. Therefore, in certain embodiments the present includes a removable and replaceable USB module 1300.

FIG. 13A shows, in side perspective view, a portion 1302 of a USB module 1300 prepared according to principles of the invention. Portion 1302 includes a receptacle 1304 compliant with, for example, any existing USB standard. It should be understood, of course, that proprietary receptacles may also be used in similar fashion.

In the illustrated embodiment, the USB receptacle 1304 is disposed within a case and/or coating of substantially electrically insulating material 1306. An electrical plug 1308, includes first 1310 and second 1312 conductive pins supported by a substantially nonconductive structural member 1314. Structural member 1314 is mechanically connected to, and supported by, a rear surface of case or coating 1306.

FIG. 13B shows, in schematic perspective view, a ventral region of a portion 1302 of USB module 1300. In this view, electrical plug 1308 is visible, including substantially nonconductive structural member 1314. First 1316 and second 1318 electrical conductors are respectively operatively connected between electrically conductive pins 1310 and 1312 and electrical terminals 1320, 1322. Terminal 1320, 1322 are operatively connected through respective electrical traces 1324, 1326 to corresponding electrical terminals of a light-emitting diode device 1328. Terminal 1320 and 1322 are also respectively connected to internal electrical terminals of USB receptacle 1304, so as to convey electrical power supplied at pins 1310 and 1312 to a USB plug inserted into the receptacle 1304.

In certain embodiments conductors 1316 and 1318 will each include a respective insulating coating. In other embodiments, insulation for all electrical components is provided by a translucent or transparent coating covering a rear surface region 1330 of the USB module portion 1302.

FIG. 13C shows, in schematic perspective view, USB module 1300 including portion 1302, as described above and a mechanical carrier portion 1304. Portion 1302 is substantially fixedly coupled to carrier portion 1304 by any appropriate manufacturing method known in the art including, without limitation, adhesive bonding, in situ molding, etc.

In certain embodiments, the carrier portion 1304 includes a metallic material, a natural polymer material, a synthetic polymer material, and/or any other material in combination thereof adapted to provide desirable service in a particular application. In certain embodiments, a transparent or translucent polymer material will be chosen to allow light from light-emitting diode device 1328 to emerge through the material, either directly through a lower surface thereof or, by internal reflection, to cause the entire surface of the carrier portion 1304 to glow.

In other embodiments an aperture is provided in a lower surface of carrier portion 1304 adjacent to LED 1328 so as to allow light from the LED to emerge downwardly. In still other embodiments, no LED is present.

As illustrated, in certain embodiments, clearance holes, e.g., 1332, 1334 are provided to allow removable but substantially fixed coupling of the USB module 1302 to a body portion, or other portion, of a charging station according to principles of the invention.

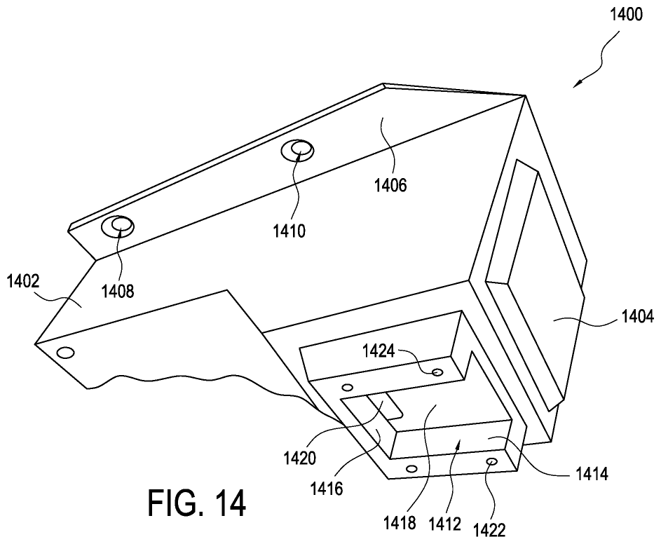

FIG. 14 shows a ventral perspective schematic view of a portion of a charging station 1400 prepared according to principles of the invention. The illustrated portion of the charging station 1400 includes a body portion 1402 a mains voltage recess 1404, a mounting flange 1406 with mounting holes 1408, 1410, and a recess 1412 for receiving a USB module. In certain embodiments of the invention, the USB module would be a removable and replaceable USB module like module 1300 shown in FIG. 13C.

As will be apparent to one of skill in the art, the recess 1412 is defined by a plurality of internal surface regions, e.g., 1414, 1416, 1418, sized and configured to accommodate the USB module. A slot 1420 in surface region 1418 is sized and located to receive conductive pins 1310, 1312 into an electrical receptacle disposed therewithin. Again, it will be clear to one of skill in the art that the sex of the plug and receptacle, and/or the nature of the actual connecting device will be selected according to the requirements of a particular application.

In the illustrated embodiment, internally threaded bores, e.g. 1422, 1424 are arranged to align with, for example, clearance holes such as exemplary clearance holes 1332, 1334, and receive fasteners such as machine screws therewithin. In this way, the USB module 1300 is fixedly coupled to body portion 1402, but is readily removable and replaceable when such action is desirable.

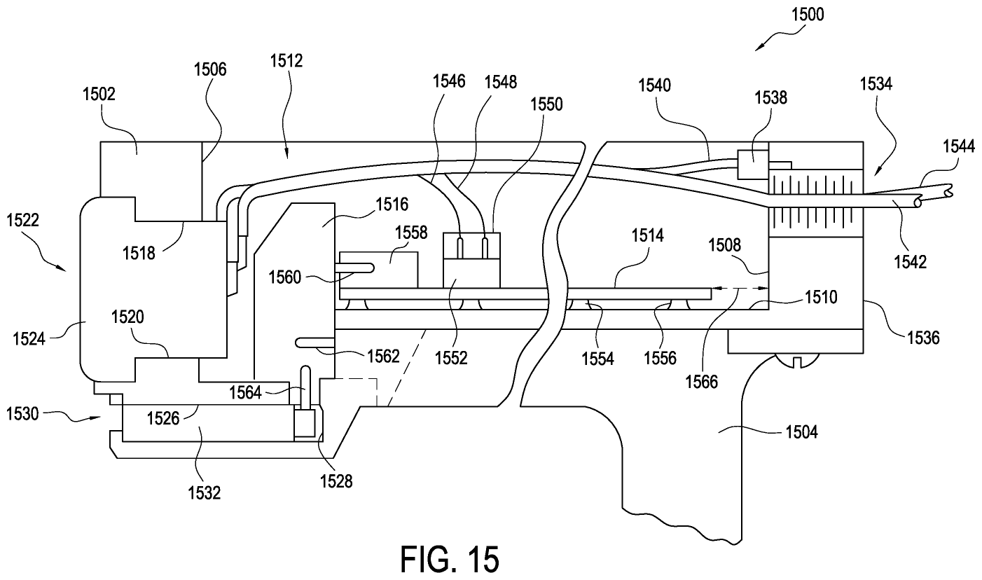

FIG. 15 shows, in schematic cross-section, a side elevation of a charging station 1500 prepared according to principles of the invention. The charging station 1500 includes a body portion 1502 and a convenience feature module 1504. A first plurality of internal surface regions 1506, 1508, 1510 of the body portion 1502 define a cavity 1512 within the body portion. Within the cavity 1512 are disposed, inter alia, an exemplary printed circuit board 1514 and a power distribution module 1516.

Further internal surface regions, e.g., 1518, 1520 define a first receptacle aperture 1522 within which is disposed a first receptacle device 1524. Additional internal surface regions 1526, 1528 define a second receptacle recess 1530 within which is disposed a second receptacle device 1532.

An internally threaded bore 1534 is disposed through a distal surface region 1536 of the body portion 1502, and is arranged and configured to receive and support therewithin, for example, a standard coupling device for any of, and without limitation, a flexible electrical cable, an armored cable, a flexible conduit, a rigid conduit, an EMT conduit, a liquid tight conduit, or any other electrical wiring device, with or without strain relief, as might be employed in the art. In certain embodiments of the invention, the body portion 1502 includes an electrically conductive material. In such an embodiment, a connection device 1538 (such as, e.g., a crimp on connection) is provided so that a ground conductor 1540 of the first receptacle device 1524 is effectively coupled (through the conductive housing and the coupling device) to a grounded conduit or armored cable. In other embodiments, ground conductor 1540 will pass through internally threaded bore 1534 for grounding within an existing electrical system.

Also disposed within internally threaded bore 1534 are respective portions of mains power supply conductors including, for example, a hot conductor 1542 and a neutral conductor 1544.

In the illustrated embodiment, the hot conductor 1542, the neutral conductor 1544 and the ground conductor 1540 are operatively connected to respective terminals of first receptacle 1524 so as to supply mains power to a plug inserted into that receptacle.

In addition, a further hot conductor 1546 is spliced or otherwise operatively connected to first hot conductor 1542 and a further neutral conductor 1548 is spliced or otherwise operatively connected to neutral conductor 1544. Conductors 1546, 1548 are operatively connected to a supply receptacle 1550. Receptacle 1550 is removably connected to a supply plug 1552 of circuit board 1514 so as to supply, for example, mains power to the circuit board.

In the exemplary embodiment illustrated, circuit board 1514 is isolated from any conductive material in the body portion 1502 by insulating standoffs, e.g., 1554, 1556. The circuit board 1514 operates to receive mains power at supply plug 1552 and produce a desirable output voltage, e.g. 5 V DC nominal, for operation of the second receptacle device 1532, where that second receptacle device is USB module.

Accordingly, in the illustrated embodiment, 5 V DC is available at output receptacle 1558. Power distribution module 1516 includes, for example conductive pins 1560 arranged and configured to align with, and operatively couple to, output receptacle 1558. The conductive pins 1560 are, in turn, connected by internal low-voltage conductors (not shown) of the power distribution module which supply power to input pins 1562 of the convenience feature module 1504, and to input pins 1564 of the second receptacle device 1532.

In this way, the internal conductors of power distribution module 1516 serve to operatively connect the various low-voltage devices and receptacles of the charging station body 1502 and the convenience feature module 1504 to the output receptacle 1558 of the circuit board 1514.

Based on the foregoing description, one of skill in the art will readily comprehend and, with a minimum of experimentation produce, a power distribution module according to principles of the invention. In particular, it will be understood that in a typical case, the power distribution module will include an insulating material such as a synthetic thermoplastic or thermoset polymer. In various embodiments, this polymer will be machined or molded to receive conductive elements, such as miniature bus bars and spring terminals, or will be molded with these elements in situ.

It will be noted that a clearance dimension 1566 is provided between a distal end of the circuit board 1514 and internal surface region 1508 of body portion 1502. This clearance dimension allows disengagement of receptacle 1558 from electrically conductive pins 1560. As will be discussed below in relation to FIG. 18, alternative arrangements are possible.

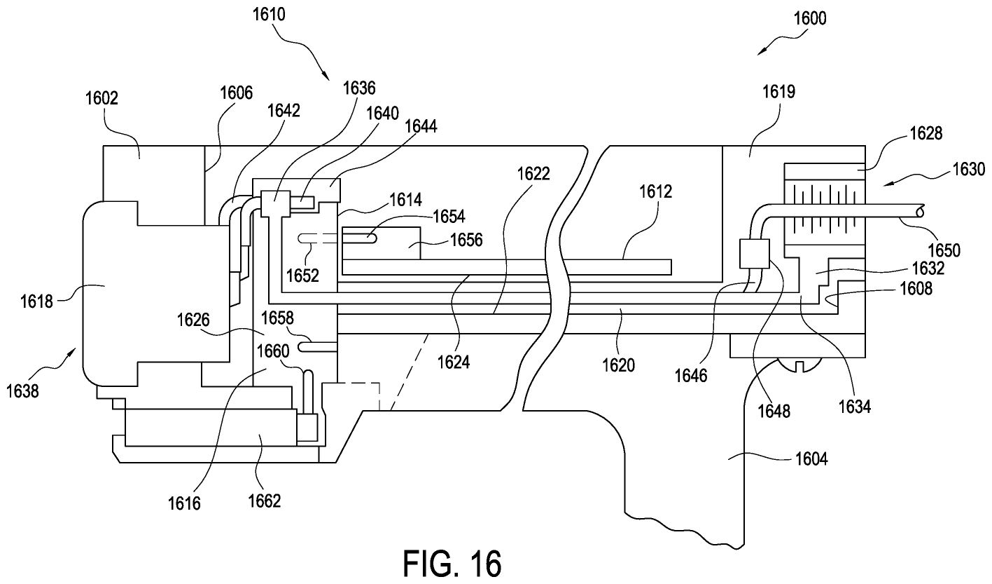

FIG. 16 shows, in schematic cross-section, a side elevation of a charging station 1600 prepared according to principles of the invention. The charging station 1600 includes a body portion 1602 and a convenience feature module 1604. A first plurality of internal surface regions 1606, 1608 of the body portion 1602 define a cavity 1610 within the body portion. Within the cavity 1610 are disposed, inter alia, an exemplary printed circuit board 1612 and a power distribution module 1614.

Referring now to FIGS. 15 and 16 it will be noted that power distribution module 1614 differs from power distribution module 1516. Specifically, power distribution module 1614 includes a proximal portion 1616 disposed in proximity to a mains power receptacle 1618, much as power distribution module 1516 is disposed in proximity to mains power receptacle 1524.

Power distribution module 1614, however, also includes a distal portion 1619 and a medial portion 1620. Medial portion 1620 is disposed between proximal portion 1616 and distal portion 1619, and between an upper internal surface region 1622 of body portion 1602 and a lower surface region 1624 of printed circuit board 1612.

As in the case of power distribution module 1516, power distribution module 1614 has a structural portion 1626 including a substantially insulating material such as, for example, an insulating thermoset polymer. Disposed within this structural portion 1626 are a plurality of electrical conductors including, e.g., mains voltage conductors and low-voltage conductors. As also described herewith, in certain embodiments of the invention, coupling devices such as for example, insulation displacement electrical connectors and crimp on electrical connectors are disposed within the insulating structural portion.

In the illustrated embodiment, a conductive metallic insert 1628 is disposed within distal portion 1619 of power distribution module 1614. The conductive metallic insert 1628 has an internally threaded bore 1630. The internally threaded bore 1630 is configured to receive a support therewithin, for example, a standard coupling device for any of, and without limitation, a flexible electrical cable, an armored cable, a flexible conduit, a rigid conduit, an EMT conduit, a liquid tight conduit, or any other electrical wiring device, with or without strain relief, as might be employed in the art. In the illustrated embodiment, the conductive metallic insert 1628 is coupled by, for example, a crimp on connector, weldment, a screw, a rivet or other connecting device 1632, to an internal ground conductor 1634 of the power distribution module 1614.

In other embodiments of the invention, for example, internal ground conductor 1634 is integrally formed with the conductive metallic insert 1628 so as to provide a ground connection to the mains electrical system. In still other embodiments of the invention, grounding is provided by connection of the internal ground conductor 1634 to a flexible ground conductor received through bore 1630. Such connection will be made in any appropriate manner, such as, for example, by crimp on connection.

In the illustrated embodiment, the internal ground conductor 1634 is connected to, or integrally formed with, for example, an insulation displacement connector 1636. Accordingly, during manufacturing assembly of the charging station 1600, power distribution module 1614 is placed within cavity 1610 of the body 1602 of the charging station 1600. Mains power receptacle 1618 is inserted into an aperture 1638 at a proximal end of body portion 1602. A ground wire conductor 1640 of mains power receptacle 1618, precut to an appropriate length, is inserted into insulation displacement connector 1636.

Also inserted into respective insulation displacement connectors are a neutral wire conductor 1642 of mains power receptacle 1618 and a hot wire conductor (not shown). A cover portion 1644 of the power distribution module 1614 is closed, either manually or by machine action, thereby actuating the insulation displacement connectors and effectively coupling the ground wire conductor 1640, the neutral wire 1642 conductor and the hot wire conductor (not shown) to their respective internal conductors e.g., 1634 of the power distribution module 1614.

As noted above, at its distal end, the ground internal conductor 1634 of the power distribution module 1614 is coupled to the conductive metallic insert 1628. The distal end of the neutral internal conductor 1646 is connected by, for example, a crimp on connector 1648 to an external neutral conductor wire 1650. The distal end of the hot internal conductor is likewise connected by, for example, a crimp on connector (not shown) to an external hot conductor wire (also not shown).

In this manner the mains power receptacle 1618 is operatively coupled to external mains power supply conductors (e.g. neutral conductor 1650) so as to make power available to any device plugged into the mains power receptacle. Of course, in certain embodiments, overcurrent protection will be provided between the external supply wires and the receptacle in the form of a replaceable or non-replaceable fuse and/or a resettable or non-resettable circuit breaker. Such a fuse or circuit breaker, or a receptacle for such a fuse or circuit breaker will be incorporated within the power distribution module in certain embodiments of the invention.

In addition, in certain embodiments, the internal mains power conductors of the power distribution module 1614 will be manufactured to include, integrally or by connection to a modular receptacle, a receptacle that provides mains power to input plug pins, e.g., 1652 of circuit board 1612.

Also, in a fashion similar to that discussed above in relation to power distribution module 1516, power distribution module 1614 will include internal low voltage conductors and respective power distribution module pins 1654 that operatively couple low-voltage power from output plug 1656 of printed circuit board 1612 to low-voltage plug pins 1658 and 1660 of the convenience feature module 1604 and the USB module 1662 respectively.

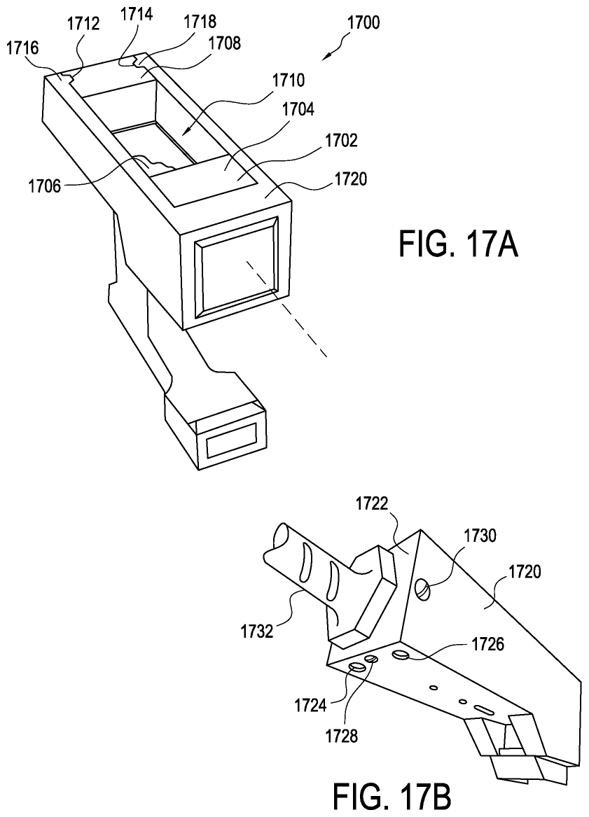

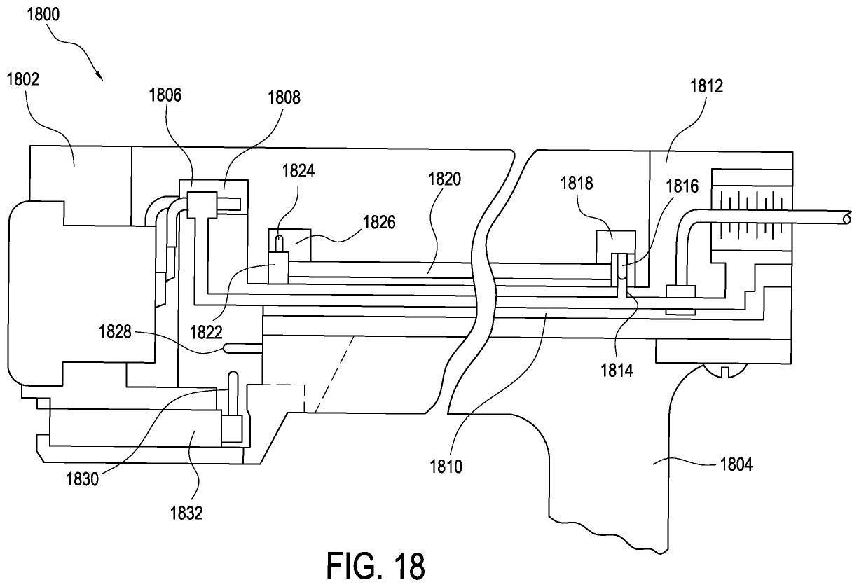

FIG. 17A shows, in cutaway schematic perspective view, a mechanical arrangement of one exemplary power distribution module for charging station 1700 prepared according to principles of the invention. Like power distribution module 1614 of FIG. 16, power distribution module 1702 includes a proximal portion 1704, a medial portion 1706 and a distal portion 1708. For illustrative purposes, a portion of a printed circuit board 1710 is shown disposed above medial portion 1706.

As will be clear upon inspection, distal portion 1708 of the illustrated embodiment includes peripheral grooves 1712, 1714 which are disposed about respective tongue portions 1716, 1718 of the body portion 1720. Referring now to FIG. 17B a reader of skill in the art will appreciate that, in the illustrated embodiment, a distal surface region 1722 of distal portion 1708 will, when the assembly is complete, form an external surface region of the body portion 1720 of the charging station.

In certain embodiments screws used for mounting a convenience feature to the body portion 1720 by insertion through mounting holes 1724, 1726 will further serve to fasten the power distribution module in place by threading into respective holes within the distal portion 1708 of the power distribution module. In other embodiments separate fasteners 1728, 1730 will be provided to secure power distribution module 1702 in place. In still further embodiments, a cover element (not shown) of the body portion 1720, and adhesive, or any other appropriate mechanism, will secure power distribution module 1702 in place.

It will be noted that, in the illustrated embodiment of FIG. 17B a conduit or armored cable coupling device 1732 is screwed directly into the above-described aperture of rear surface 1722 of power distribution module 1702.

Referring again to FIG. 15 and as previously noted, clearance 1566 is required to allow a sliding connection to be made between pins 1560 and receptacle 1558. FIG. 18 shows an alternative arrangement in which the power supply pins necessary for the circuit board are disposed vertically. Consequently, an overall length of the internal cavity, and therefore of the charging station body, may be made shorter (or the circuit board may be made longer) than in the above-disclosed embodiments.

Specifically, FIG. 18 shows an exemplary embodiment of a charging station 1800 including a body portion 1802 and a convenience feature module 1804. A power distribution module 1806 includes a proximal portion 1808, a medial portion 1810 and a distal portion 1812. A mains voltage power supply receptacle 1814 is integrated into the medial portion 1810 and arranged and configured to receive vertically oriented conductive pins 1816 of a mains voltage power supply plug 1818 of printed circuit board 1820.

In like fashion a low-voltage plug 1822 including vertically oriented conductive pins 1824 is arranged and configured to operatively couple with a low voltage output receptacle 1826 of printed circuit board 1820. As will be understood by one of skill in the art, conductive pins 1824 are internally connected to integrated receptacles 1828, 1830 of the power distribution module 1806 so as to supply low-voltage power to the convenience feature module 1804 and the USB module 1832 respectively.

In light of the foregoing, it will be clear to one of skill in the art that the present invention provides a novel and highly functional foundation on which a wide variety of individual applications will be built. In particular, the removable and replaceable attribute of the convenience feature allows for a single versatile body portion to become the foundation for a wide variety of different and beneficial services for an ultimate user.

Body portion and convenience feature modules can be provided discretely, or preassembled, or in kit form such that a user can install a single desirable convenience feature module or a wide variety of modules at a single location. Modules can be changed and updated as fashion changes, or as technology changes. For instance as one charging mode is displaced by another, rather than becoming obsolete, the body portion simply becomes the dock for a new convenience feature module.

Convenience feature modules that wear out or are broken, either mechanically or by electrical overload, are readily replaced, and a method of installing a charging station and thereafter removing and replacing a convenience feature is thus contemplated as being within the scope of the invention.

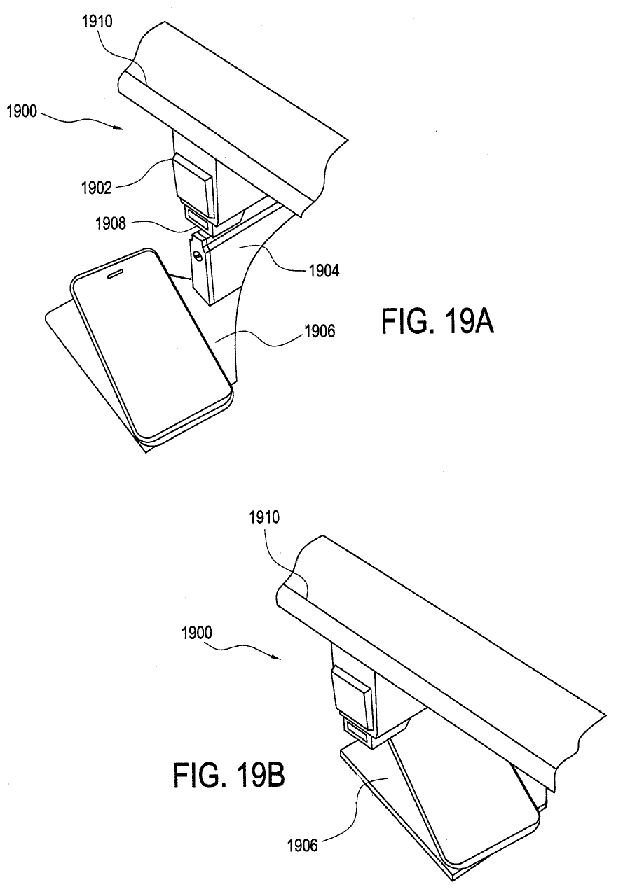

Convenience features can be provided that are appropriate to individuals of different ages and different preferences of all sorts. Convenience features may be selected for their aesthetic attributes, and their cultural attributes. Thus, for example, FIGS. 19A and 19B show a charging station 1900 with a body portion 1902 and a convenience feature module 1904.

The convenience feature module 1904 includes a shelf portion 1906 well adapted to support a smart phone. The shelf portion 1906 includes an integrated wireless charging system as described above. The convenience feature module also includes a slide apparatus 1908. In the illustrated embodiment, the slide apparatus 1908 includes a miniature ball slide, but any of a wide variety of sliding mechanisms will be employed in corresponding embodiments of the invention.

In FIG. 19A the slide apparatus 1908 is shown in a first extended configuration. Consequently, the shelf portion 1906 is disposed proximately of an edge 1910 of a tabletop beneath which the charging station 1900 is attached. In FIG. 19B, by contrast, the slide apparatus 1908 is arranged in a second retracted configuration. Consequently, the shelf portion 1906 is disposed distally of table edge 1910.

In the extended configuration, a user has easy access to the smart phone and is able to discreetly read an incoming message, or the time of day, for example, without touching the smart phone. In the retracted configuration, the phone is out of the way and less likely to be bumped by a user's knee or thigh. In both configurations, wireless charging of the smart phone is available and provides a substantial benefit for the user.

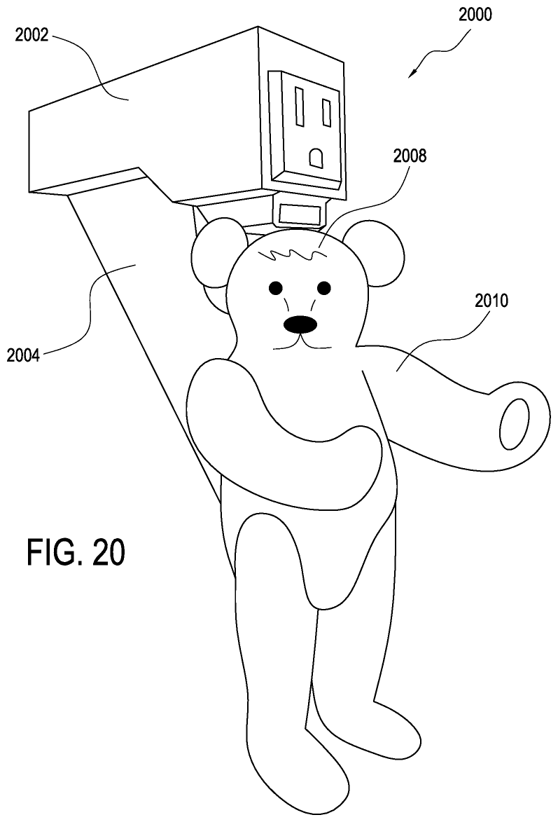

FIG. 20 shows a charging station 2000 including a body portion 2002 and a convenience feature 2004. The convenience feature 2004 here includes a bear figure 2008, but may include any doll other device that may be attractive to a child or a whimsical adult. Such articles may include soft fabrics over a substantially rigid structural skeleton, polymer loam materials, or any other material having an attractive or otherwise beneficial characteristic.

The attractive convenience feature may encourage, for example, a child to hang up his or her backpack on the bear's extended arms 2010 and plug in his or her smart phone for charging on arrival home for school. Moreover, although a child may mature and outgrow a particular convenience feature module, in light of the present invention, the obsolete module may be replaced by a new version more appropriate to the child's new age and status.

Of course, children are hardly the only market for whimsical or aesthetic articles. A charging station prepared according to principles of the invention will beneficially include a convenience feature that incorporates decorative elements, or advertising features.

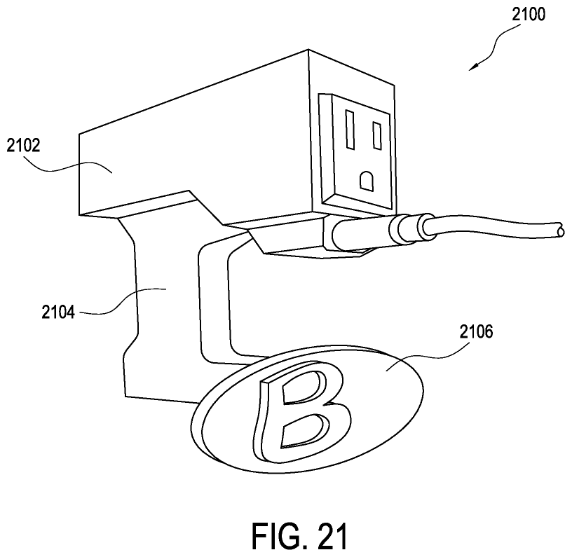

FIG. 21 shows, for example, a charging station 2100 including a body portion 2102 and a convenience feature 2104 that incorporates a brand logo or other advertising indicia 2106. Because such a convenience feature may be used in a commercial environment where rough use is apt to lead to damage, replacability of the convenience feature module can have great benefit. In addition, because the convenience feature is replaceable, branding material that becomes obsolete can be replaced with updated materials at any time.

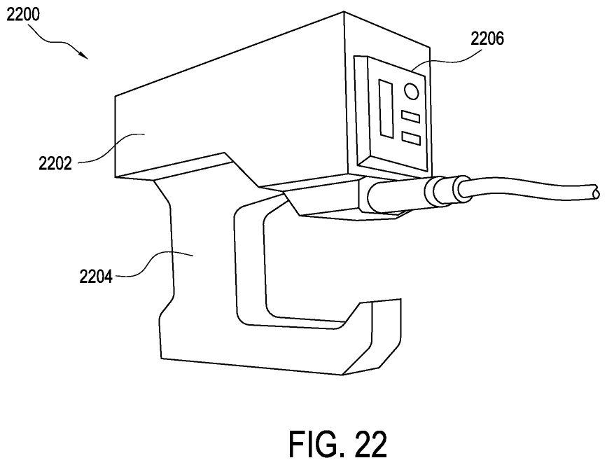

FIG. 22 shows a further charging station 2200 including a body portion 2202 and a convenience feature module 2204. In the illustrated charging station 2200 a receptacle module 2206 including one or more additional USB receptacles (USB A, USB B, USB C) or other receptacles of any appropriate standard or proprietary configuration for power and/or data connection is provided, in place of a mains voltage receptacle described above. It should also be noted that a charging station including a plurality of mains voltage receptacles is contemplated within the scope of the present disclosure.

Finally, it should be noted that although a generic form of base portion is illustrated throughout this disclosure, any of a wide variety of forms and arrangements are contemplated. Thus a base function with multiple mains voltage receptacles, or with not is intended to fall within the scope of the disclosure. Likewise, multiple USB or other low voltage receptacles will be incorporated into corresponding versions of the base portion. Alternative coupling mechanisms are anticipated for the connection between the base portion and the convenience feature.

While the exemplary embodiments described above have been chosen primarily anticipating commercial and residential installations, one of skill in the art will appreciate that the principles of the invention are equally well applied, and that the benefits of the present invention are equally well realized in a wide variety of other applications including, for example, vehicles and transportation systems, public spaces, airports, etc. Further, while the invention has been described in detail in connection with the presently preferred embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. Accordingly, the invention is not to be seen as limited by the foregoing description, but is only limited by the scope of the appended claims.

1. A charging station comprising:
a body portion, said body portion including at least one electrical receptacle; and
a removable convenience feature module substantially fixedly coupled to said body portion, said removable convenience feature module including a coupling member portion and a support column portion, said removable convenience feature module being configured and adapted to support a personal article.

2. A charging station comprising:
a body portion, said body portion including at least one mains voltage electrical receptacle and a voltage converter device, said voltage converter device being adapted to receive mains voltage input power and produce output power at a secondary voltage;
a removable convenience feature module substantially fixedly coupled to said body portion, said removable convenience feature module including a coupling member portion and a support column portion, said removable convenience feature module being configured and adapted to support a personal article; and
a further electrical receptacle, said further electrical receptacle being adapted to provide power to a personal electronic device at said secondary voltage.

3. A charging station as defined in claim 2 wherein said personal article comprises said personal electronic device.

4. A charging station as defined in claim 2 wherein said further electrical receptacle comprises a USB receptacle.

5. A charging station as defined in claim 2 wherein said removable convenience feature module comprises a pocketbook hook.

6. A charging station as defined in claim 2 wherein said further receptacle comprises a portion of said removable convenience feature module.

7. A charging station as defined in claim 2 wherein said further receptacle comprises a portion of said body portion.

8. A charging station as defined in claim 2 wherein said body portion comprises a horizontal flange member, said horizontal flange member including at least one screw hole for mounting said charging station to an underside of a piece of furniture.

9. A charging station as defined in claim 2 wherein said body portion comprises a horizontal flange member, said horizontal flange member including at least one screw hole for mounting said charging station to an underside of a restaurant fixture.

10. A charging station as defined in claim 9 wherein said restaurant fixture comprises a service bar.

11. A charging station as defined in claim 2 wherein said removable convenience feature module comprises a wireless charging interface device for a personal electronic device.

12. A charging station as defined in claim 2 wherein said removable convenience feature module comprises a light emitting diode.

13. A charging station as defined in claim 2 wherein said removable convenience feature module comprises an embedded light emitting diode adapted to cause substantially an entire surface of said convenience feature module to glow when said light emitting diode is illuminated.

14. A charging station as defined in claim 2 wherein said removable convenience feature module comprises a support shelf for a personal electronic device.

15. A charging station as defined in claim 14 wherein said support shelf comprises a wireless charging apparatus for charging said personal electronic device.

16. A charging station as defined in claim 2 wherein said removable convenience feature module comprises a mounting member, a support shelf for a personal electronic device, and a sliding apparatus disposed between said mounting member and said support shelf.

17. A charging station as defined in claim 16 wherein said support shelf comprises a wireless charging apparatus for said personal electronic device.

18. A charging station as defined in claim 2 wherein said removable convenience feature module comprises advertising indicia.

19. A charging station as defined in claim 2 wherein said removable convenience feature module comprises a toy figure.

20. A charging station as defined in claim 2 wherein said charging station comprises a power distribution module including a proximal portion, a distal portion, and a medial portion disposed between said proximal portion and said distal portion, said medial portion including a plurality of mains voltage electrical conductors disposed therewithin.
